(19) United States
(12) Patent Application Publication
(10) Pub. No.: US 2004/0262923 A1
(43) Pub. Date: Dec. 30, 2004

(54) Pipe assembly

(76) Inventor: Ralph Peter Hegler, Bad Kissingen (DE)

Correspondence Address: BARNES & THORNBURG LLP, P.O. Box 2786, Chicago, IL, 60690-2786, US

(21) Appl. No.: 10/877,599

(22) Filed: Jun. 25, 2004

(30) Foreign Application Priority Data
Jun. 26, 2003 (DE) 103 28 626.8

(51) Int. Cl. F16L 37/00

(52) U.S. Cl. 285/374; 285/903

(57) ABSTRACT

A pipe assembly comprises a first pipe section and a second pipe section of which at least one pipe section is provided with a spigot which is provided with outwardly annularly extending projections with flanks. A seal is arranged between two adjacent projections against their flanks. At least those projections between which the seal is arranged are formed as projections of increased wall thickness forming a portion of increased wall thickness and comprising a higher filling ratio than more distantly arranged projections.

### BACKGROUND OF THE INVENTION

1. Field of the Invention

The present invention relates to a pipe assembly with a first pipe section, with a second pipe section, with a spigot formed on at least one pipe section, which is at least partially provided with outwardly annularly extending projections with flanks and which receives a seal between two adjacent projections which seal is arranged against their flanks and with a socket for interconnecting the first and second pipe sections wherein the socket receives the spigot. Such pipe assemblies are known, for example, from U.S. Pat. No. 5,320,797, U.S. Pat. No. 5,996,635, U.S. Pat. No. 5,992,469 and U.S. Pat. No. 6,343,623.

2. Background Art

It has been shown in practice that pipes with larger pipe diameters or with a larger radial extension of the projections cannot be inserted one into the other in a durably fluid-tight way. This particularly refers to thermoplastic materials. This is particularly disadvantageous in water reserves where a durable sealing is required at a pressure of 1 to 3 bar in the pipes including the pipe joints.

### SUMMARY OF THE INVENTION

It is therefore an object of the present invention to provide a pipe assembly of the generous kind which provides the possibility of inserting pipes one into the other in a durably fluid-tight way, in particular pipes made of thermoplastic materials.

According to the present invention, this object is achieved by projections between which the seal is arranged and which are formed as projections of increased wall thickness forming a portion of increased wall thickness and comprising a higher filling ratio than more distantly arranged projections. The essence of the present invention consists in reinforcing the spigot in the area directly surrounding the seal. This reinforcement or increase in thickness can be achieved by reducing the speed of the moulds or by increasing the material flow from one of the extruders or from both extruders. The object of the present invention does not consist in increasing the annular rigidity of the spigot, which could also be achieved by suitably shaping the profile of the annular projections without reinforcing the walls or increasing their thickness, but solely in better compensating the forces exerted by the seal on the radially outwardly extending projections. In other words, the object consists in reinforcing the radially outwardly extending annular projections into which the seal closely fits in such a way that said projections can durably produce the reaction power required for providing a durable sealing.

Further features, advantages and details of the invention will become apparent from the ensuing description of embodiments, taken in conjunction with the drawings.

### BRIEF DESCRIPTION OF THE DRAWINGS

FIG. 1 shows a first embodiment of a pipe assembly in partial longitudinal section which pipe assembly is continuously manufactured from a pipe section, an integral sleeve, a spigot, and another pipe section;

FIG. 2 shows a pipe joint between the pipe sections after cutting the twin wall pipe in two;

FIG. 3 shows a second embodiment of a pipe assembly in a representation similar to FIG. 2;

FIG. 4 shows a third embodiment of a pipe assembly in a representation similar to FIG. 2;

FIG. 5 shows the third embodiment of a pipe assembly with an additional tightening strap;

FIG. 6 shows a fourth embodiment of a pipe assembly in a representation similar to FIG. 2;

FIG. 7 shows a fifth embodiment of a pipe assembly with ribbed-pipe shaped pipe sections in a representation similar to FIG. 2; and

FIG. 8 shows a sixth embodiment of a pipe assembly with a double socket.

### DESCRIPTION OF THE PREFERRED EMBODIMENTS

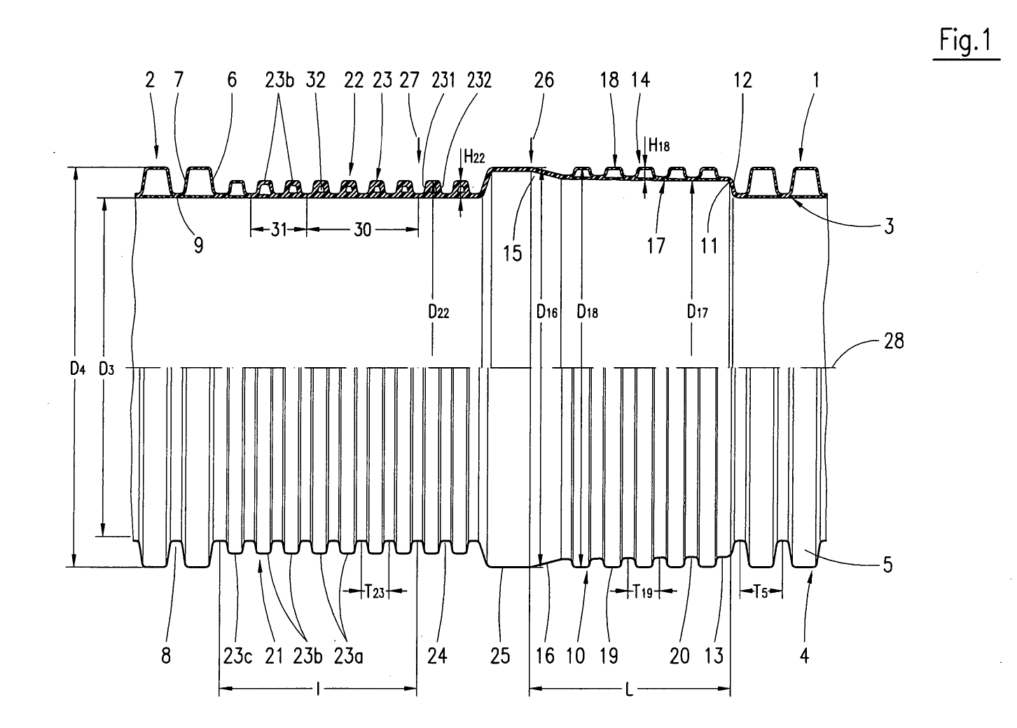

As shown in FIG. 1, a twin wall pipe is continuously manufactured in one pipeline, which substantially consists of the actual pipe sections 1, 2. Said pipe sections 1, 2 usually comprise an even-walled cylindrical internal pipe 3 and a corrugated external pipe 4. Said external pipe 4 comprises radially outwardly extending annular projections in the form of approximately trapezoidal corrugation crests 5 wherein a corrugation trough 8 is formed between each flanks 6, 7 of two adjacent corrugation crests 5. At the base 9 of each corrugation trough 8 the external pipe 4 is welded to the internal pipe 3. Such twin wall pipes of the described design are commonly known and used in practice.

Between the two pipe sections 1, 2 and adjacent to the pipe section 1 there is arranged an integral sleeve 10 which in the area of the integral sleeve base 11, that is adjacent to an extension section 12 of the pipe section 1, comprises a short even-walled cylindrical section 13. Similar to the extension section 12, said even-walled section 13 is not a double-walled section, but mainly a single-walled section. Adjacent to the even-walled section 13 there is arranged a twin wall pipe section 14 adjacent to which the integral sleeve 10 is single-walled again comprising an inlet section 16 which is outwardly flared towards an inlet port 15. The twin wall pipe section 14 is principally similar to the pipe sections 1, 2, which means that it comprises a substantially cylindrical even-walled internal pipe section 17 and a corrugated first external pipe section 18 with radially outwardly extending annular projections in the form of corrugation crests 19 wherein again each first external pipe section 18 is welded to the internal pipe section 17 in the area of the corrugation troughs 20. The corrugation crests 19 are substantially arranged over the full length of the integral sleeve 10, except for the inlet section 16 and the short section 13.

Between the integral sleeve 10 and the pipe section 2 and directly adjacent to the latter there is arranged a spigot 21 whose inner surface is formed and defined by the internal pipe 3. Said spigot 21 comprises a corrugated second external pipe section 22 with radially outwardly extending annular projections in the form of corrugation crests 23 wherein again each second external pipe section 22 is welded to the internal pipe 3 in the area of the corrugation troughs 24. The corrugation crests 23 comprise flanks 231, 232. The outside contours of all corrugation crests 5, 19, 23 are substantially annular-cylindrical.

Between the integral sleeve 10 and the spigot 21 there is arranged a transition section 25 which is cut out by saw cuts 26, 27 (see FIG. 1) and thus becomes waste. Since this cutting operation is carried out continuously, each pipe section 1 or 2 comprises an integral sleeve 10 on its one end and a spigot 21 on its other end.

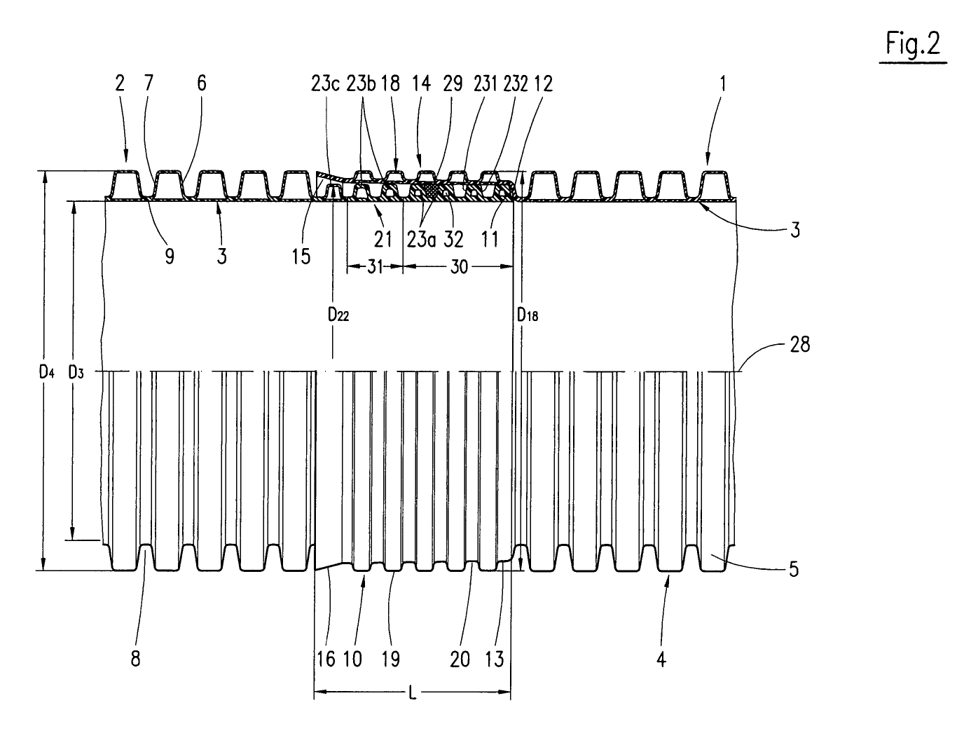

As shown in FIG. 2, the spigot 21 of the pipe section 2 is adapted to be inserted into the integral sleeve 10 of the adjacent pipe section 1 whereby two pipe sections 1, 2 are interconnected. Upon fully inserting the spigot 21 into the integral sleeve 10, the front corrugation crest 23 contacts the extension section 12 in the area of the integral sleeve base 11 (see FIG. 2). Consequently, the corrugation crest 5 which is arranged adjacent to the spigot 21 is arranged directly adjacent to the inlet port 15 of the inlet section 16 of the integral sleeve 10 whereby the length L of the spigot 21 approximately corresponds to the length L of the integral sleeve 10.

The pipe sections 1, 2 have an outside diameter D₄ which corresponds to the outside diameter of the external pipe 4 and have an inside diameter D₃ which corresponds to the inside diameter of the internal pipe 3. The outside diameter D₁₈ of the integral sleeve 10 corresponds to the outside diameter of the first external pipe section 18 wherein the outside diameter D₁₆ of the inlet section 16 is not greater than D₁₈ as a rule. The outside diameter D₂₂ of the spigot 21 corresponds to the outside diameter of the second external pipe section 22.

The inside diameter D₁₇ of the integral sleeve 10 corresponds to the inside diameter of the internal pipe section 17. Under consideration of a slight clearance and the production tolerances the outside diameter D₂₂ of the spigot 21 approximately corresponds to the inside diameter D₁₇ of the integral sleeve 10 wherein 1.01 D₂₂≦D₁₇≦1.04 D₂₂. The proportion between the outside diameter D₁₈ of the integral sleeve 10 and the outside diameter D₄ of the pipe sections 1, 2 is: D₄≈D₁₈.

The total height H₂₂ of the corrugation crests 23 of the second external pipe section 22 including the wall thickness of the internal pipe 3 is greater than the total height H₁₈ of the corrugation crests 19 including the thickness of the internal pipe section 17 of the first external pipe section 18 of the integral sleeve 10 wherein 0.3(H₁₈+H₂₂)≦H₁₈≦0.7(H₁₈+H₂₂). As further shown in the drawing, the proportion between the pitch T₁₉ of the corrugation crests 19 of the integral sleeve 10 and the pitch T₅ of the corrugation crests 5 of the pipe sections 1, 2 towards the central longitudinal axis 28 is: 0.3 T₅≦T₁₉≦0.7 T₅. As far as the pitch T₂₃ of the corrugation crests 23 of the spigot 21 is concerned, the proportion is in the same way: 0.3 T₅≦T₂₃0.7 T₅.

The above description has shown that both the axial extension and the radial extension of the corrugation troughs 24 of the spigot 21 are considerably smaller than those of the corrugation troughs 8 of the pipe sections 1, 2. Therefore, the volume of an annular seal 29 which is arranged in the corugation trough 24 against the flanks 231, 232 of adjacent corrugation crests 23 can be considerably smaller than an annular seal which would have to be arranged in a corrugation trough 8.

The endless twin wall pipe between each two pipe sections 1 and 2 of which there are formed an integral sleeve 10 and a spigot 21 in an in-line process is manufactured according to a known method which is, for example, illustrated and described in U.S. Pat. No. 5,320,797 or U.S. Pat. No. 5,992,469 to which reference may be made.

The twin wall pipe described herein so far is known from U.S. Pat. No. 6,578,608. The fact that the spigot 21 is reinforced in the area of the seal 29 is a specific feature in comparison with the known embodiment. For this purpose, the second external pipe section 22 and/or the internal pipe 3 comprise a higher wall thickness in this area than in the remaining area (see FIGS. 1 and 2). This reinforcement or increase in thickness, particularly of the second external pipe section 22 and the internal pipe 3 in this area, is suitably achieved, according to U.S. Pat. No. 5,320,797, by reducing the speed of the followers of the moulds of the machine used for manufacturing the pipe and/or by increasing the material flow from the extruder for the pipe to be manufactured. The portion of increased wall thickness 30 should extend at least over one corrugation crest 23a on either side of the seal 29, but more suitably over two corrugation crests 23a on either side of the annular seal 29. The drawing shows that in the uncut twin wall pipe of

FIG. 1 the portion 30 extends until the transition section 25, so a part is cut out by saw at 26, 27. As further shown in FIGS. 1 and 2, there is a transition section 31 of decreasing wall reinforcement or thickness adjacent to the portion 30 seen in a direction from the spigot 21 to the pipe section 2 which pipe section is integrally formed with the spigot. Said transition section 31 extends over one to three corrugation crests 23b and in the shown embodiment over two corrugation crests 23b.

The reinforcement of the walls or their increased thickness in the portion of increased wall thickness 30 is defined by the filling ratio. The available cross-section, that is the profile which is defined by the internal pipe 3 on the inside and by the outer profile of the corrugation crests 23a on the outside, is filled with more material (at least 100% more) than the corrugation crests 23b in the portions without increased wall thickness. In other words, at least the double quantity of material is used for generating the second external pipe section 22 in the portion of increased wall thickness 30 compared with the remaining portions of the spigot 21 where the corrugation crests 23c comprise no increased thickness wherein the upper limit is naturally reached when the internal cavities 32 of the corrugation crests 23a are completely filled up. By forming the spigot 21 in the portion of increased wall thickness 30 in the described way, it is possible to suitably compensate the forces exerted by the seal 29 on the corrugation crests 23a and particularly on their flanks 231, 232. Thus, the reaction power exerted by the corrugation crests 23a and particularly their flanks 231, 232 on the seal 29 is constant during a long service life so that the fluid-tight connection between the spigot 21 and the integral sleeve 10 can be maintained. The force of pressure exerted by the seal 29 on the integral sleeve 10 does not decrease when the flanks 231, 232 give way.

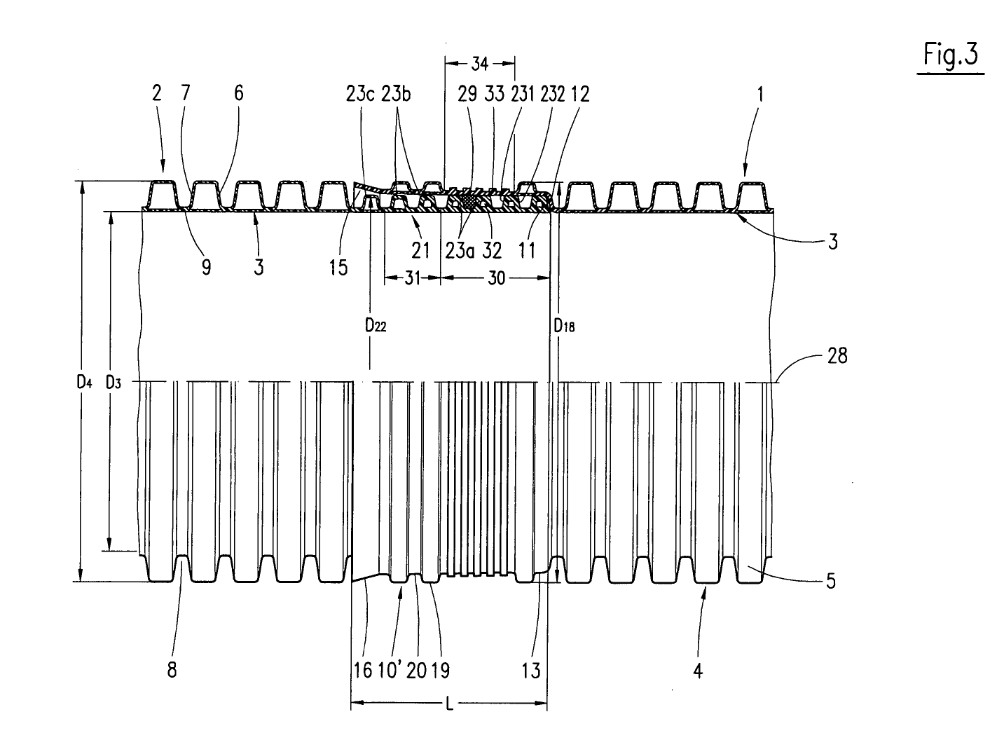

The only difference between the second embodiment according to FIG. 3 and the embodiment according to FIGS. 1 and 2 is that the outside of the integral sleeve 10′ is not provided with corrugation crests 19 over its full length L. Instead, relatively flat annular webs or ribs 33 are arranged between corrugation crests 19 over a part of the length L. The portion 34 which is provided with annular webs or ribs 33 overlaps the portion of increased wall thickness 30 when the spigot 21 is inserted in the integral sleeve 10′.

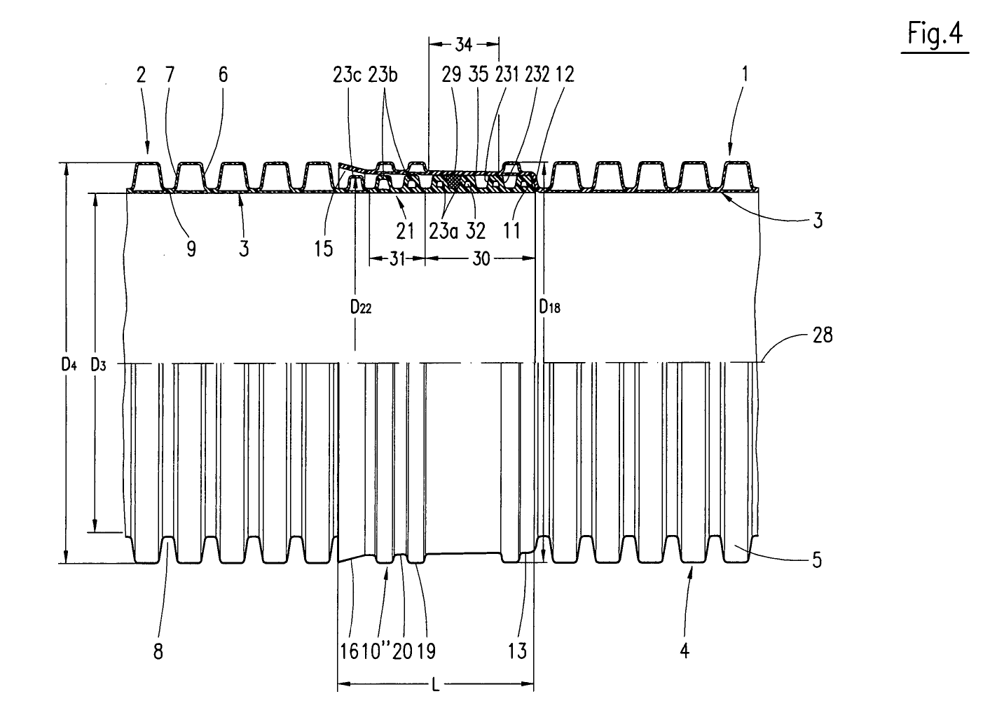

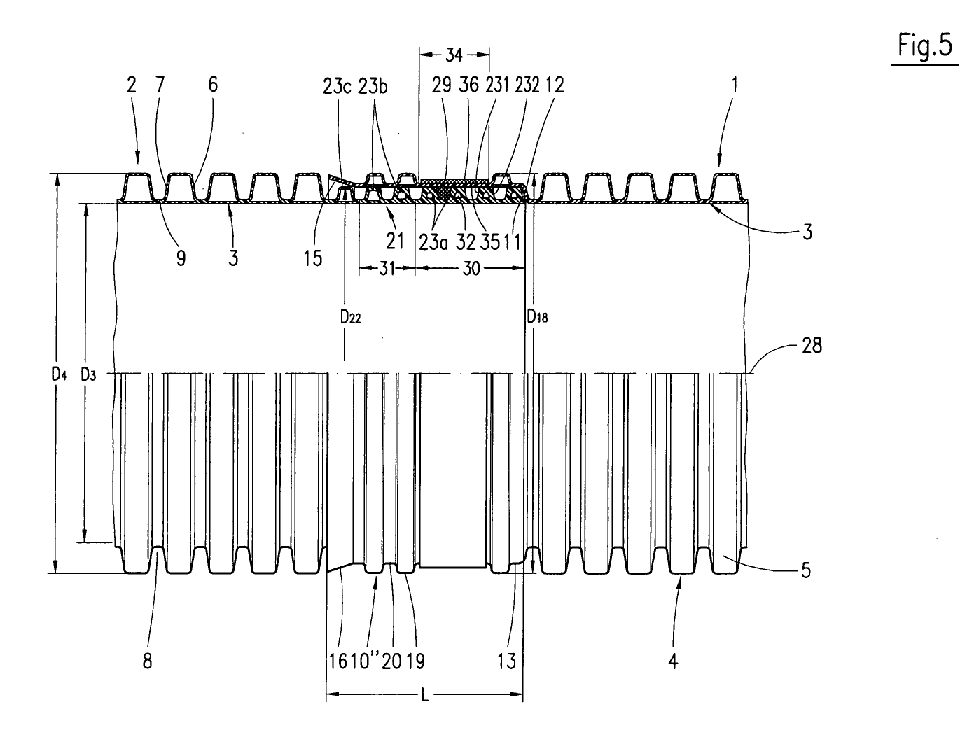

The difference between the third embodiment according to FIGS. 4 and 5 and the embodiments according to FIGS. 1 and 2 and according to FIG. 3 respectively is that the integral sleeve 10″ comprises an even-walled section 35 in its portion 34. In particular with great nominal widths, a tightening strap 36 may be provided in the portion 34 after interconnecting the pipe sections 1 and 2 (see FIG. 5).

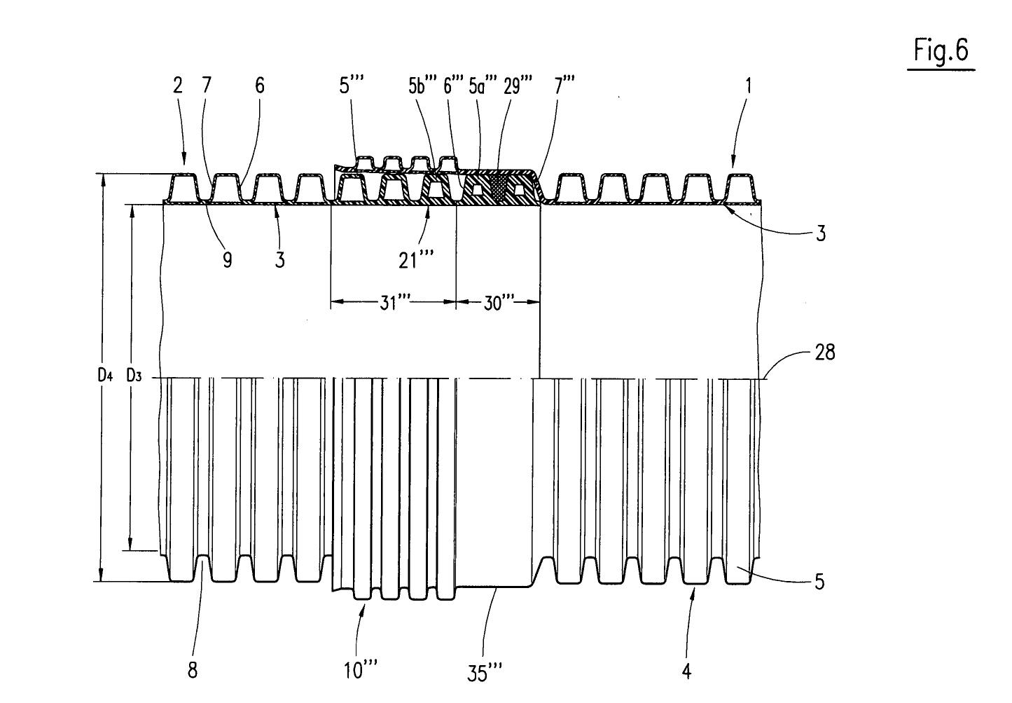

In the fourth embodiment according to FIG. 6 also the spigot 21′″ of the pipe section 2 comprises corrugation crests 5′″ which have the same outer profile as the corrugation crests 5 in the remaining portion of the pipe section 2. The spigot 21′″ comprises a portion of increased wall thickness 30′″ which in this case comprises only one corrugation crest 5a′″ on either side of the seal 29′″. The transition section 31′″ of decreasing wall thickness of the corrugation crests 5b′″ extends over three corrugation crests in this case. As far as the filling ratio is concerned, the above remarks apply. The integral sleeve 10′″ comprises an even-walled section 35′″ over the portion of increased wall thickness 30′″ when the spigot 21′″ is inserted in the integral sleeve 10′″. Again, a tightening strap 36 may be provided around said even-walled section 35 ′″.The seal 29′″ is arranged against the flanks 6′″, 7′″ of two adjacent corrugation crests 5a′″.

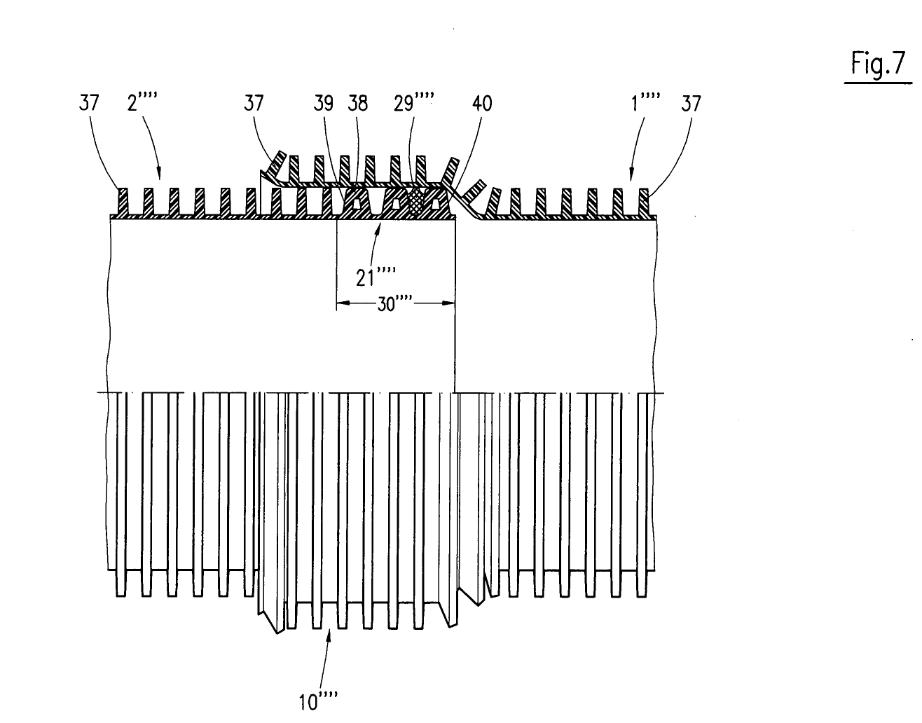

In the fifth embodiment according to FIG. 7 the pipe sections 1″″ and 2″″ are also formed as twin wall pipes, but comprise radially outwardly extending annular projections in the form of ribs 37. The portion of the spigots 21″″, however, comprises radially outwardly extending annular projections in the form of corrugation crests 38 with flanks 39, 40. Naturally, in this embodiment a seal 29″″ is arranged against the flanks 39, 40 of adjacent corrugation crests 38 in each portion of increased wall thickness 30″″. The integral sleeve 10″″ is also provided with ribs 37.

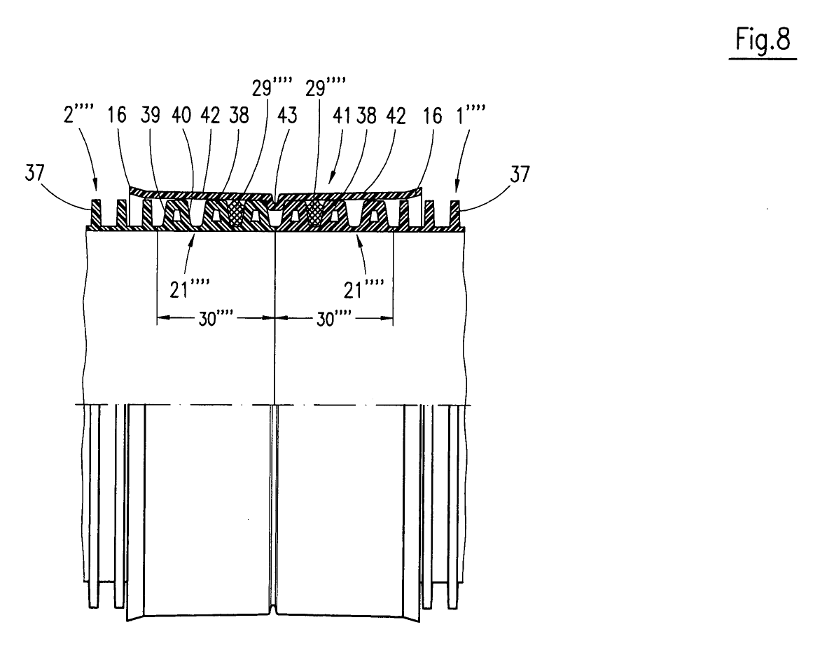

The difference between the sixth embodiment according to FIG. 8 and the embodiments described above, particularly the embodiment according to FIG. 7, is that the socket is formed as a double socket 41 which is separated from the pipe sections 1″″ and 2″″. Said socket comprises two cylindrical sections 42 which are arranged symmetrically in relation to each other. A radially inwardly extending annular stop web 43 is arranged between said cylindrical sections 42 which each comprise an inlet section 16 on their ends. Both pipe sections 1″″ and 2″″ each comprise one spigot 21″″ which contacts the stop web 43 when it is inserted into the respective cylindrical section 42 of the socket 41.

What is claimed is:

1. A pipe assembly
with a first pipe section (1, 1″″);
with a second pipe section (2, 2″″);
with a spigot (21, 21′″, 21″″) formed on at least one pipe section (1, 2, 1″″, 2″″);
which is at least partially provided with outwardly annularly extending projections with flanks (231, 232, 6′″, 7′″, 39, 40) and
which receives a seal (29, 29′″, 29″″) between two adjacent projections which seal is arranged against their flanks (231, 232, 6′″, 7′″, 39, 40); and
with a socket (10, 10′, 10″10′″, 10″″, 41 ) for interconnecting the first and second pipe sections (1, 2, 1″″, 2″″) wherein the socket (10, 10′, 10″, 10′″, 10″″, 41) receives the spigot (21, 21′″, 21″″); wherein
at least those projections between which the seal (29, 29′″, 29″″) is arranged are formed as projections of increased wall thickness forming a portion of increased wall thickness (30, 30″″, 30″″) and comprising a higher filling ratio than more distantly arranged projections.

2. A pipe assembly according to claim 1, wherein
the pipe sections (1, 2, 1″″, 2″″) are formed as twin wall pipes and wherein
at least the projections on the spigot (21, 21′″, 21″″ are formed as corrugation crests (23, 5′″, 38).

3. A pipe assembly according to claim 1, wherein
the socket is an integral sleeve (10, 10′, 10″, 10′″, 10″″ formed on the end of the first pipe section (1) and wherein
only the second pipe section (2) comprises a spigot (21, 21′″, 21″″).

4. A pipe assembly according to claim 1, wherein
a transition section (31, 31 ′″) of decreasing filling ratio is formed adjacent to the portion of increased wall thickness (30, 30′″).

5. A pipe assembly according to claim 4, wherein
the transition section (31, 31′″) comprises between one and three projections.

6. A pipe assembly according to claim 1, wherein
the filling ratio of the projections in the portion of increased wall thickness (30, 30′″, 30′″) is at least double as high as that of more distantly arranged projections.

7. A pipe assembly according to claim 1, wherein
the projections of the pipe sections (1, 2) are formed as corrugation crests (5).

8. A pipe assembly according to claim 1, wherein
the socket is formed as a double socket (41) which is separated from the pipe sections (1″″, 2″″) and overlaps one spigot (21″″) on each pipe section (1″″, 2″″).

9. A pipe assembly according to any one of claims 1, wherein
the projections of the pipe sections (1″″, 2″″) are formed as ribs (37).

10. A pipe assembly according to claim 1, wherein
the integral sleeve (10, 10′, 10″″) comprises an increased wall thickness around the portion of increased wall thickness (30) of the spigot.
